(19) United States
(12) Patent Application Publication
(10) Pub. No.: US 2005/0041831 A1
(43) Pub. Date: Feb. 24, 2005

(54) Electromagnetic transducer motor structure with radial thermal extraction paths

(76) Inventors: Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 10/646,568

(22) Filed: Aug. 22, 2003

(51) Int. Cl. H04R 9/06; H04R 1/02; H04R 11/02

(52) U.S. Cl. 381/412; 381/395; 381/421

(57) ABSTRACT

An electromagnetic transducer motor structure such as for an audio speaker. The motor structure has a non-magnetically conductive heatsink in the middle of its magnetic circuit members. A set of magnetically conductive members extend through the heatsink to conduct magnetic flux across the thickness of the heatsink, completing the magnetic circuit. The heatsink includes spokes or webs which extend between these members, to carry heat away from the voice coil area to a heatsink body outside the motor structure. The heatsink may optionally include an inner ring to sink eddy currents generated by the voice coil, reducing eddy current heating of the less thermally conductive and more electrically resistive plates and magnets of the motor structure. The heatsink body may optionally form the basket of the speaker.

### RELATED APPLICATION

This application is related to co-pending application Ser. No. 10/289,109 “Push-Push Multiple Magnetic Air Gap Transducer” filed Nov. 5, 2002, and co-pending application Ser. No. 10/289,080 “Electromagnetic Transducer Having a Low Reluctance Return Path” filed Nov. 5, 2002, by Enrique M. Stiles, co-applicant of the present patent application.

### BACKGROUND OF THE INVENTION

1. Technical Field of the Invention

This invention relates generally to electromagnetic transducers such as audio speakers, and more specifically to a motor structure geometry having radial thermal extraction paths.

2. Background Art

FIG. 1 illustrates a conventional speaker 10 with an external magnet geometry motor structure 12 driving its diaphragm assembly 14. The motor structure includes a pole plate 16 style yoke, made of soft magnetic material and including a back plate 18 and a pole piece 20 that are either magnetically coupled or of integral construction. The pole plate may optionally include a ventilation hole 22 for depressurizing the diaphragm assembly. One or more external ring hard magnets 24 are magnetically coupled to the back plate. A top plate 26 of soft magnetic material is magnetically coupled to the hard magnets. A magnetic air gap 28 is formed between the top plate and the pole piece.

The diaphragm assembly includes a basket 30 which is mechanically coupled to the motor assembly to support the other, moving parts of the diaphragm assembly. A diaphragm 32, sometimes referred to as a cone, is coupled to the basket by a flexible suspension component known as a surround 34. A voice coil former or bobbin 36 is mechanically coupled to the diaphragm, and is coupled to the basket by a flexible suspension component known as a spider 38. The surround and spider allow the bobbin and diaphragm to move axially with respect to the motor structure, but prevent, as much as possible, their lateral movement and rocking. An electrically conductive voice coil 40 is wound around and mechanically coupled to the bobbin, and is disposed within the magnetic air gap of the motor structure. A dust cap 42 is coupled to the diaphragm to seal the open end of the bobbin.

FIG. 2 illustrates such a motor structure, shown in exploded perspective view. The motor structure 12 includes a pole plate 16, one or more magnets 24, and a top plate or drive plate 26. A basket or frame 30 is coupled to the motor structure.

FIG. 3 illustrates the motor structure 12 in non-exploded perspective view, with a cutaway. The pole plate 16 is magnetically coupled to the one or more magnets 24. The top plate 26 is magnetically coupled to the top of the magnet stack, and defines a magnetic air gap 28 between itself and the pole piece. The basket 30 is coupled atop the top plate. The speaker is vented for depressurization and cooling through axial hole 22 through the pole piece. Unfortunately, this is an inadequate cooling solution for high power applications in which, e.g., a subwoofer is driven by a large amplifier. The voice coil (not shown) generates significant amounts of heat, which in turn heats the nearby structures. Furthermore, induced eddy currents in the pole piece, top plate, and other conductive components contribute significantly to heating of the motor structure. In many instances, the amount of eddy current heating may be in the same magnitude as the heating caused by the voice coil.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIGS. 1-3 show, in perspective view, a conventional external magnet geometry speaker according to the prior art.

FIGS. 4-5 show one embodiment of an external magnet geometry speaker according to this invention.

FIG. 6 shows one embodiment of a basket for use with the speaker of FIGS. 4-5.

FIGS. 7-8 show another embodiment of an external magnet geometry speaker according to this invention.

FIG. 9 shows one embodiment of a basket for use with the speaker of FIGS. 7-8.

FIGS. 10-11 show still another embodiment of an external magnet geometry speaker according to this invention.

FIG. 12 shows one embodiment of a basket for use with the speaker of FIGS. 10-11.

FIG. 13 shows one embodiment of a speaker according to a different embodiment of this invention, in which multiple radial heat extraction members are employed.

FIG. 14 shows one embodiment of a radial heat extraction member which is not a basket and which may be employed with, for example, the speaker of FIG. 13.

FIG. 15 shows, in perspective view with a cutaway, an internal magnet geometry motor structure according to another embodiment of this invention.

FIG. 16 shows one embodiment of a radial thermal extraction member which may be used in the motor structure of FIG. 15.

FIG. 17 shows another embodiment of an internal magnet geometry motor structure according to this invention, having both radial and axial thermal extraction paths.

FIG. 18 shows one embodiment of a soft or hard magnet structure having integral magnetically conductive spacer elements.

FIG. 19 shows one embodiment of a push-pull geometry motor structure including a radial thermal extraction member.

FIG. 20 shows one embodiment of a radial thermal extraction member such as may be used in the motor structure of FIG. 19.

FIGS. 21-23 shows another embodiment of an internal magnet geometry motor structure and its radial thermal extraction basket which has both radial metal thermal paths and radial air ventilation paths.

FIGS. 24-25 show another dual gap embodiment of the invention.

FIG. 26 shows another embodiment of the invention adapted for use in a push-pull motor.

FIG. 27 shows one embodiment of a radial thermal extraction member such as may be used in the motor structure of FIG. 26.

FIG. 28 shows a close-up view of a magnet segment and its plate connectors such as may be used in the motor structure of FIG. 26.

FIGS. 29-30 show another embodiment of the invention, including a hybrid extended/t-pole, integrated back plate and spacer elements, and dual eddy current rings.

FIGS. 31-33 show another embodiment of the invention, with both metal and air radial thermal extraction paths in an external magnet geometry motor.

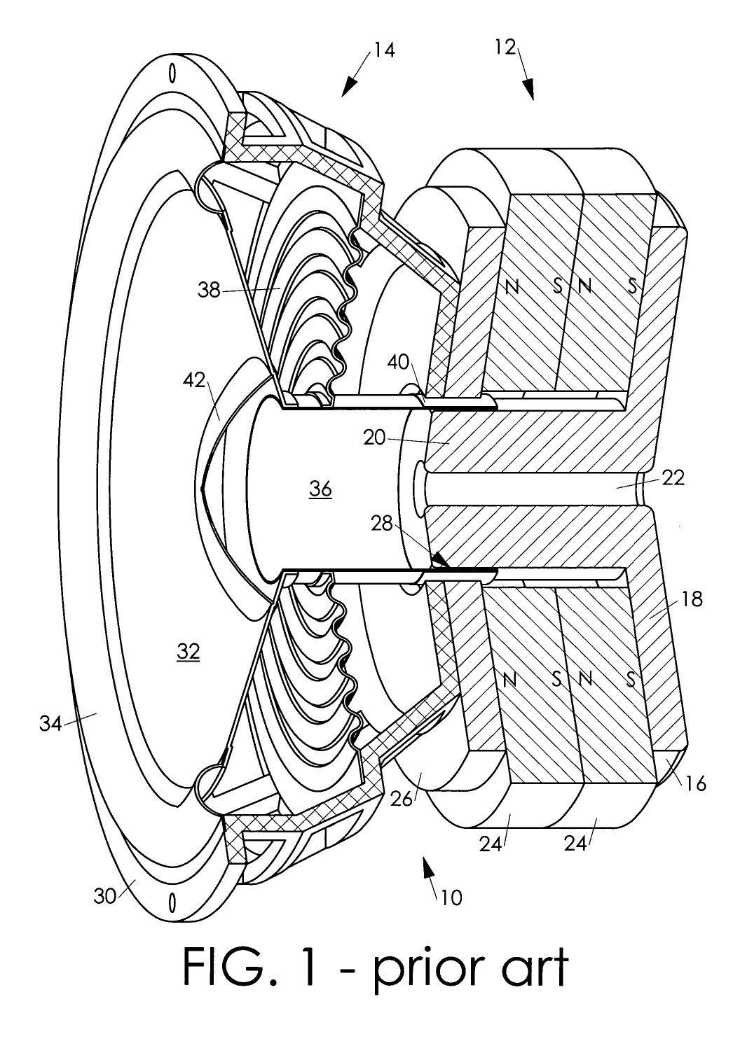

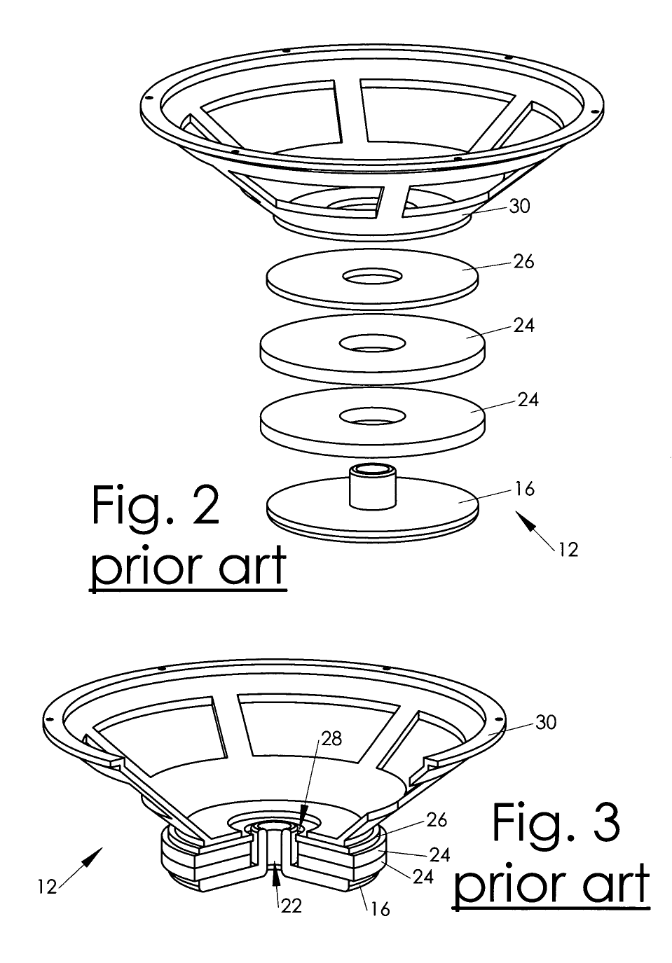

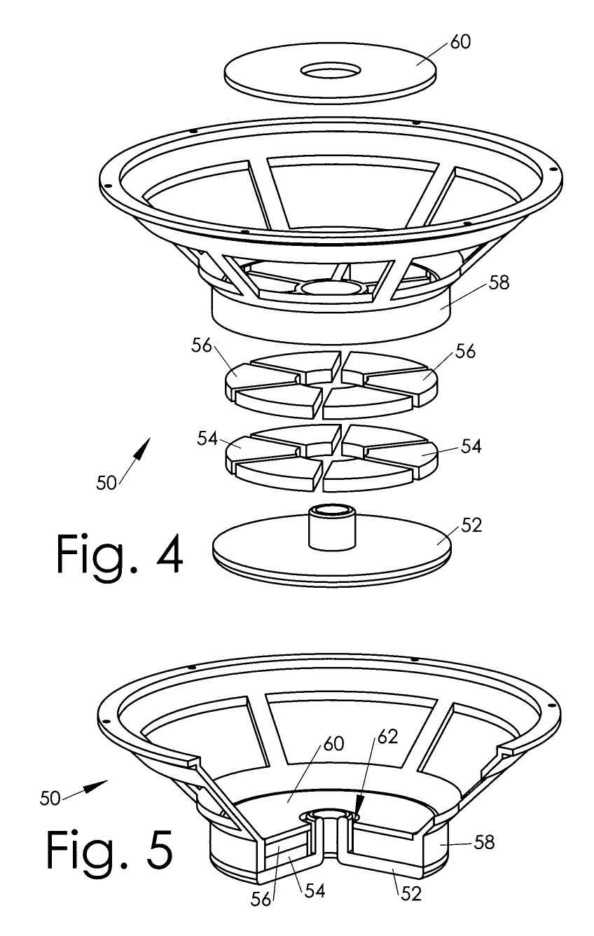

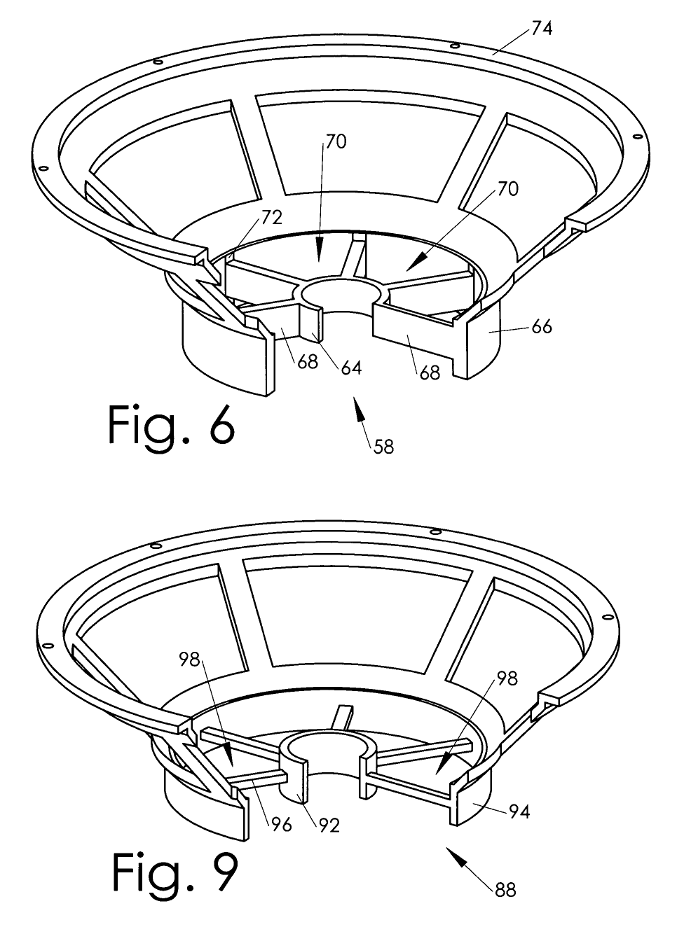

### DETAILED DESCRIPTION

The invention may be utilized in a variety of magnetic transducer applications, including but not limited to audio speakers, microphones, mechanical position sensors, actuators, and the like. For the sake of convenience, the invention will be described with reference to audio speaker embodiments, but this should be considered illustrative and not limiting. The invention may prove especially useful in high power applications such as subwoofer speakers, but, again, this should not be considered limiting.

FIG. 4 illustrates, in exploded perspective view, one embodiment of an electromagnetic transducer motor structure 50 according to this invention. The motor structure includes a pole plate 52, one or more magnets 54, 56 which are segmented in a citrus-like manner, a basket 58, and a top plate 60.

FIG. 5 illustrates, in non-exploded perspective view with a cutaway, the motor structure 50. The stack of one or more segmented magnets 54, 56 are magnetically coupled to the pole plate 52, and the top plate 60 is magnetically coupled to the magnets and defines a magnetic air gap 62 between itself and the pole piece. The basket 58 is coupled to the motor structure and includes material dispersed throughout the citrus-like structure of the magnets.

FIG. 6 illustrates, in perspective view with a cutaway, one embodiment of a basket 58 such as is suitable for use with the motor structure of FIGS. 4-5. The basket optionally, but quite advantageously, includes an inner conduction ring 64 which serves two significant purposes. First, the inner diameter (ID) of the ring is sized to be in close proximity to the moving voice coil (not shown), to absorb heat from the voice coil e.g. by convection and/or radiation. Second, if the ring is a continuous loop, it acts as a sink for induced eddy currents, particularly if the ring is made of a low-resistance conductor such as aluminum. The ring is thermally coupled to an outer heatsink member 66 by one or more webs 68. The webs may extend radially from the ring to the outer member, but other configurations are also possible within the scope of this invention. Spaces 70 between the webs are where the magnet segments (not shown) are disposed when the motor structure is assembled. In one embodiment, the outer member extends upward enough to provide an outer rim 72 which is sized to hold the outer diameter (OD) of the top plate (not shown).

Less heat is generated with this motor structure than with the prior art motor structure, when the conductive inner ring is made from a material with a lower electrical resistance than the soft magnetic material used in the magnetic circuit and therefore less heated by induced eddy currents. Because the inner ring would have lower electrical resistance than, for example the top plate, eddy currents will form in the inner ring far more readily than in the top plate. With the inner ring physically and therefore electrically being one portion of the basket, then the entire basket is, in effect, one giant shorted turn, with ultra low electrical resistance.

And, significantly, what heat there is generated in this motor structure is carried away from the heating zone with far greater efficiency than in the prior art motor structure, because the directly (or integrally) connected aluminum webs provide a much lower thermal resistance path to the outside of the motor structure than do the magnets and plates of the prior art motor structure. This efficiency is raised even more in the case where the bulk of the basket is in direct thermal contact with the webs and inner ring, especially in the case where the entire basket is fabricated as a monolithic component.

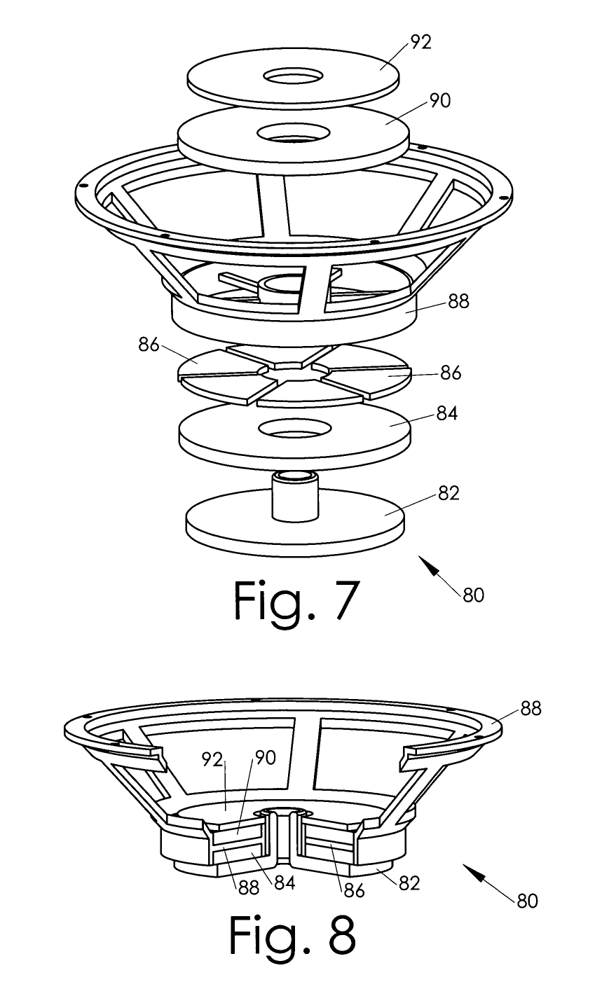

FIG. 7 illustrates, in exploded perspective view, another embodiment of a motor structure 80 according to this invention. The speaker includes a pole plate 82, a lower ring magnet 84, segmented steel spacers 86, a basket 88, an upper ring magnet 90, and a top plate 92.

FIG. 8 illustrates, in non-exploded perspective view with a cutaway, the motor structure 80. The lower ring magnet 84 is magnetically coupled to the pole plate 82. The segmented magnetically conductive spacers 86, such as steel, are magnetically coupled between the lower ring magnet and the upper ring magnet 90. The top plate 92 is magnetically coupled to the upper ring magnet. The basket 88 is coupled to the motor structure, and includes portions that are interspersed through it, somewhat as described above.

FIG. 9 illustrates, in perspective view with a cutaway, the basket 88 in greater detail. The basket includes an inner ring 92 coupled to an outer heatsink member 94 by one or more webs 96. Spaces 98 between the webs are where the segments of the steel ring are disposed when the motor structure is assembled. Because ring magnets are used instead of segmented magnets, the webs do not extend to the top and bottom of the inner ring, and are only as thick as the segmented steel ring.

One advantage which this configuration offers is that the designer can increase voice coil assembly clearance by simply using a thicker segmented steel ring and correspondingly thicker webs, rather than having to make complicated or expensive alterations to the back plate of the pole plate. This web configuration enables the use of an inexpensive, flat pole plate. It should be noted that various modifications can be made in the motor structure without deviating from the scope of this invention; for example, either of the ring magnets could be omitted, or additional ring magnets could be added, or a non-flat pole plate could be used, and so forth.

FIG. 10 illustrates, in exploded perspective view, another embodiment of a motor structure 100 according to this invention. The motor structure includes a pole plate 102, one or more segmented ring magnets 104, 106, a basket 108, and a segmented top plate 110. The basket includes radiator fins to improve thermal transfer to the ambient air.

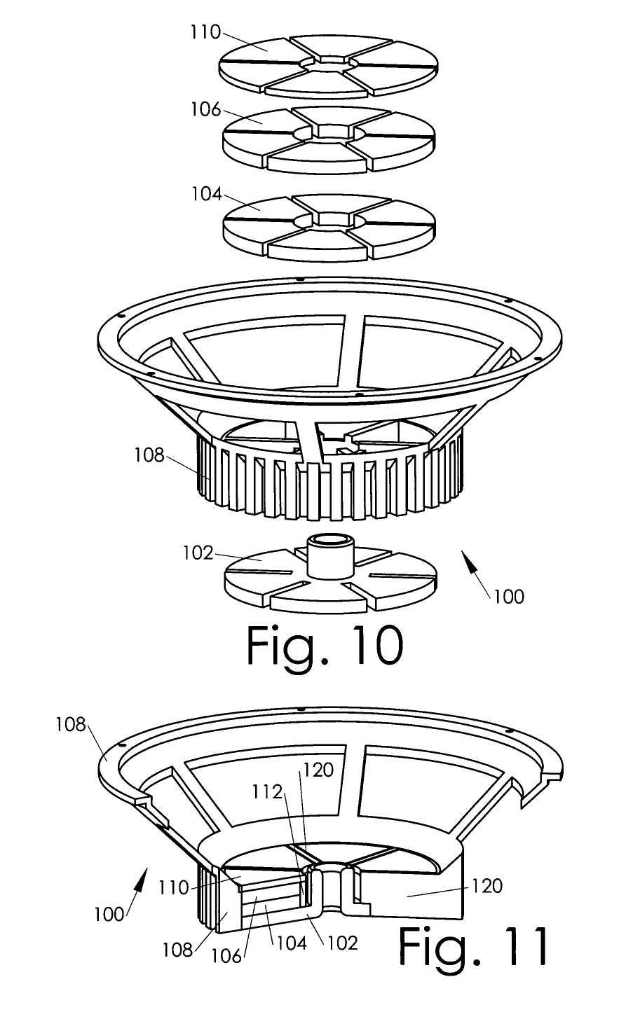

FIG. 11 illustrates, in non-exploded perspective view with a cutaway, the speaker 100. The stack of one or more segmented magnets 104, 106 is magnetically coupled to the pole plate 102, and the segmented top plate 110 is magnetically coupled to the magnets. The basket 108 is coupled to the motor structure.

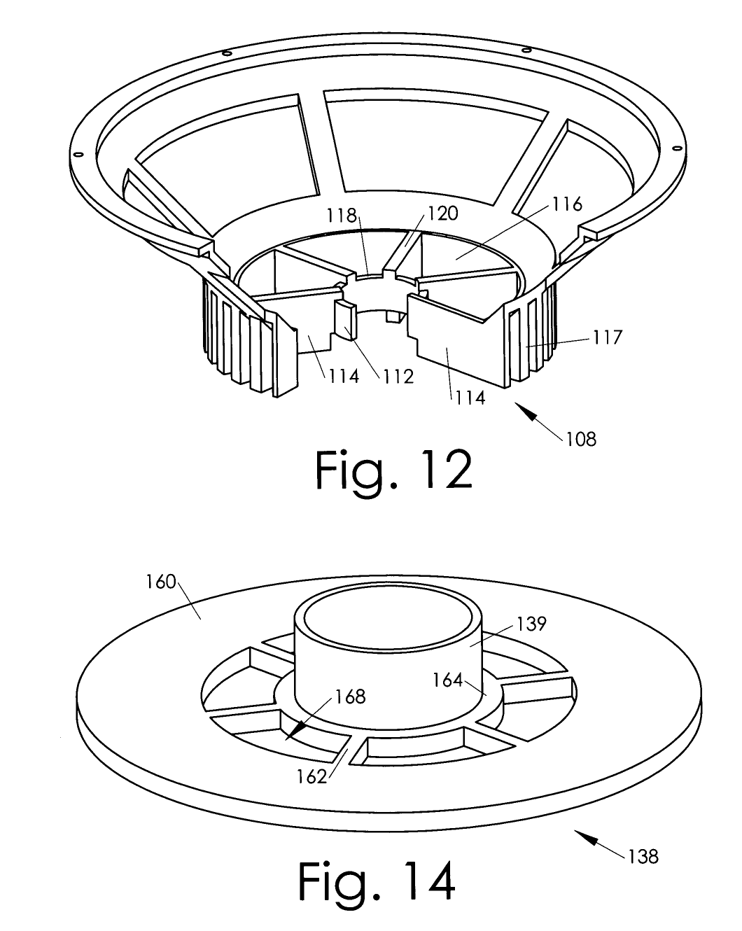

FIG. 12 illustrates, in perspective view with a cutaway, further details of the basket 108. An inner ring 112 is coupled by one or more webs 114 to an outer heatsink member 116 which may be adapted with optional radiator fins 117. The inner ring is adapted with grooves 118 into which the inner ends of the top plate segments (not shown) fit when the motor structure is assembled. The webs include upper surfaces 120 which extend through the segmented top plate. In some embodiments, additional heatsink members (not shown) such as an aluminum cap plate can be placed into contact with these surfaces 120 to provide shorter or lower resistance heat extraction paths away from the inner ring.

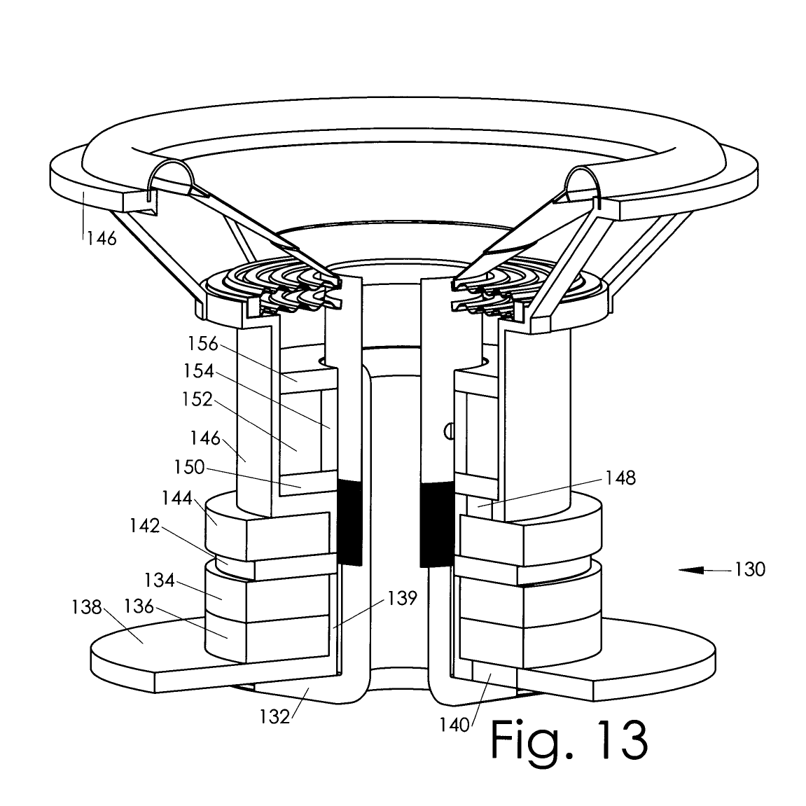

FIG. 13 illustrates another embodiment of a speaker 130 according to the principles of this invention. The speaker includes an elongated pole plate 132. One or more magnets 134, 136 are magnetically coupled to the back plate of the poleplate by segmented magnetic material members 140 such as steel or magnets which extend through a first segmented radial heat extraction member 138 such as an aluminum heatsink. The first heat extraction member 138 can take any suitable shape. A disc shape is shown merely for convenience; the invention is not thus limited. The heatsink may include an inner ring portion 139 which extends upward to center the inner diameters of the magnets. Typically, magnets are set back from the pole plate farther than the drive plates are; by extending the radial heat extraction member into this extra space, an increase is achieved in the surface area of the radial heat extraction member which is in close proximity to the voice coil, and, additionally, an increase is achieved in the volume and area of low resistance induction current sink ring material which is in close proximity to the voice coil.

A drive plate 142 is magnetically coupled to the magnets 134, 136 and defines a lower drive magnetic air gap between itself and the pole piece. Optionally, another magnet 144 is magnetically coupled to the lower drive plate, and is magnetically oriented with its poles in the same direction as those of the lower magnets, for balancing the upper and lower magnetic circuits. A second segmented radial heat extraction member 146 is configured as a basket for the speaker, as described above. The basket has disposed within its segmented voids a set of magnetic material members 148 such as steel or magnets, to magnetically couple the magnet 144 to a second drive plate 150 which defines an upper drive magnetic air gap between itself and the pole piece. Thus, this embodiment of the speaker utilizes not only the present invention, but also the multi-gap geometry of the first co-pending application identified above.

A bucking magnet 152 is coupled atop the upper drive plate, and has its magnetic polarity opposite that of the lower magnets. A low electrical resistance non-magnetic ring 154 is disposed between the bucking magnet and the pole piece, and serves as yet another sink for induced eddy currents. A return path plate 156 is coupled atop the bucking magnet and defines a low reluctance return path magnetic air gap (which is not used for driving a voice coil) between itself and the pole piece. Thus, this embodiment of the speaker also utilizes the return path geometry of the second co-pending application identified above.

FIG. 14 illustrates the non-basket segmented heat extraction member or heatsink 138 in greater detail. It is made of any suitable material, such as aluminum, and can take any suitable shape and configuration. In some embodiments, it, rather than the upper heatsink, may serve as the speaker's basket. The heatsink includes a heatsink body 160 which is connected by webs or spokes 162 to an inner ring portion 164 which may, optionally, include an extension 139 for extending between a magnet and the pole piece. A series of voids 168 are where the magnetic material members (not shown) are disposed to more readily conduct magnetic flux through the thickness of the heatsink from e.g. one magnet to another or from a magnet to a steel plate or the like.

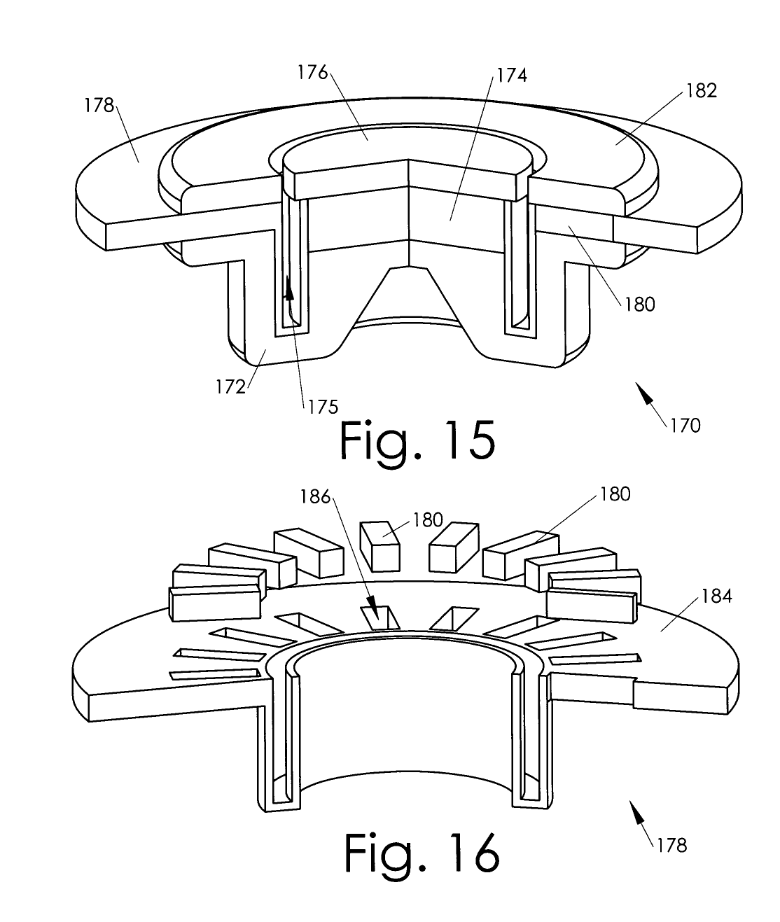

FIG. 15 illustrates yet another embodiment of a motor structure 170 using the principles of this invention. The motor structure has an internal magnet geometry and includes a cup 172 in which is disposed a magnet 174 such as a neo disc magnet. For voice coil clearance, the cup includes a cutout 175 between the cup's vertical perimeter portion and the internal raised portion to which the magnet is magnetically coupled. A drive plate 176 is magnetically coupled atop the magnet.

Because this speaker uses an internal magnet geometry, the radial heat extraction member or heatsink 178 is employed in conjunction with the external cup rather than in conjunction with the magnet and plate stack, which are internal. A set of magnetically conductive members 180 such as magnets or steel extend through the heatsink and magnetically couple the lower portion 172 of the cup to an upper portion 182 of the cup. In some embodiments, the magnetically conductive members 180 are separate components, as illustrated; in other embodiments, they may be formed as integral extensions of the lower portion 172 of the cup and/or of the upper portion 182 of the cup. Optionally, the outer perimeter of the magnet may be fitted with an electrically conductive eddy current sink ring (not shown).

FIG. 16 illustrates one embodiment of a heatsink 178 such as that used in FIG. 15. The heatsink includes a thermal mass body 184 (which may optionally form a basket). A set of voids 186 are for receiving the magnetically conductive members 180 which magnetically couple the lower portion of the cup to the upper portion of the cup.

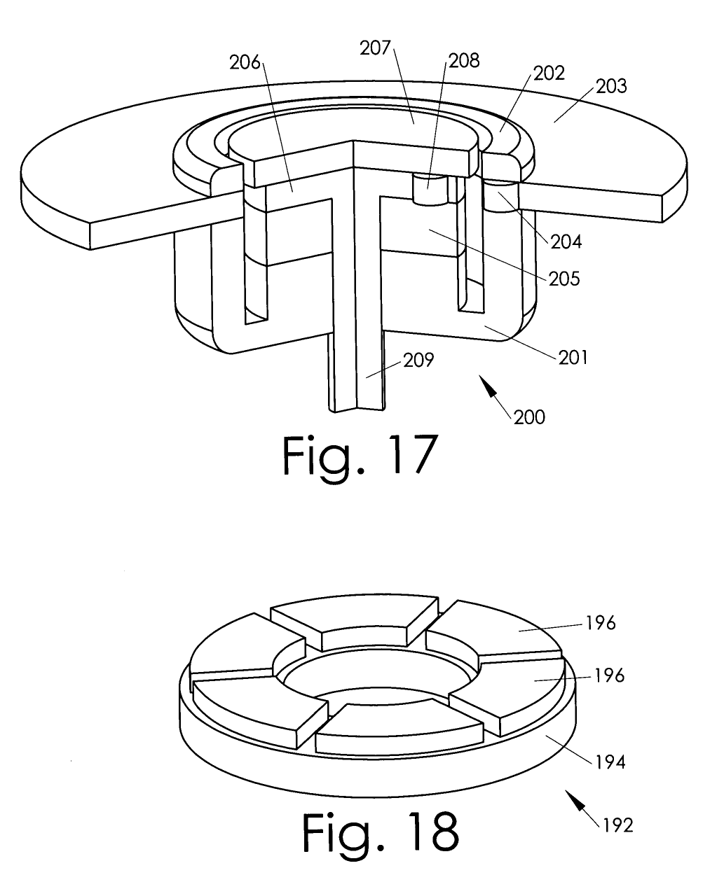

FIG. 17 illustrates another embodiment of an internal magnet motor structure 200. The motor structure includes a cup which is comprised of a lower cup 201 and an upper cup lip 202 which are magnetically coupled through a non-magnetically conductive heatsink 203 by magnetically conductive plugs 204. An internal magnet 205 is magnetically coupled to the lower cup. An internal heatsink 206 is coupled between the internal magnet and an internal top plate 207. The internal heatsink includes a plurality of voids through which magnetically conductive plugs 208 magnetically couple the magnet to the top plate. The magnet and the lower cup each includes an axial hole, to permit insertion of an axle portion 209 of the heatsink through the holes from the top. The outer perimeter of the internal heatsink is exposed to the voice coil (not shown), and conducts heat away from the voice coil area through webs between the magnetically conductive plugs to the heatsink axle. Although not shown, further heatsink attachments may be coupled to the heatsink axle, especially in the case where, as shown, it extends beyond the bottom of the cup. For clarity of illustration, the plugs 204 and 208 are not shown in cutaway view.

In another embodiment, the top plate 207 could also have an axial hole, and the internal heatsink could have a second axle portion extending upward through the top plate. In some embodiments, a phase plug or other heatsink component could be coupled to this second axle. This would enable extracting heat to the external environment outside a speaker enclosure.

FIG. 18 illustrates an embodiment of a magnetically conductive member 192, either a permanent magnet or a steel plate, which includes a main body 194 with which the set of magnetically conductive spacer elements 196 are integrally formed. This may simplify assembly of the transducer, with fewer parts to manage. In some embodiments, a portion of the extruding segmented hard or soft magnets may be integral with a plate (or magnet) which is disposed on a first side of a heatsink such as those illustrated above, while the remainder of the extruding segmented hard or soft magnets may be integral with a plate (or magnet) which is disposed on an opposite side of the heatsink. Alternatively, the segmented pieces may each comprise a piece partially extending from e.g. a first magnet and a piece partially extending from a second magnet. These may permit a single sku of component to be used on both sides of the heatsink, further simplifying assembly and inventory. Other configurations will be apparent to the skilled reader, upon studying the teachings of this patent.

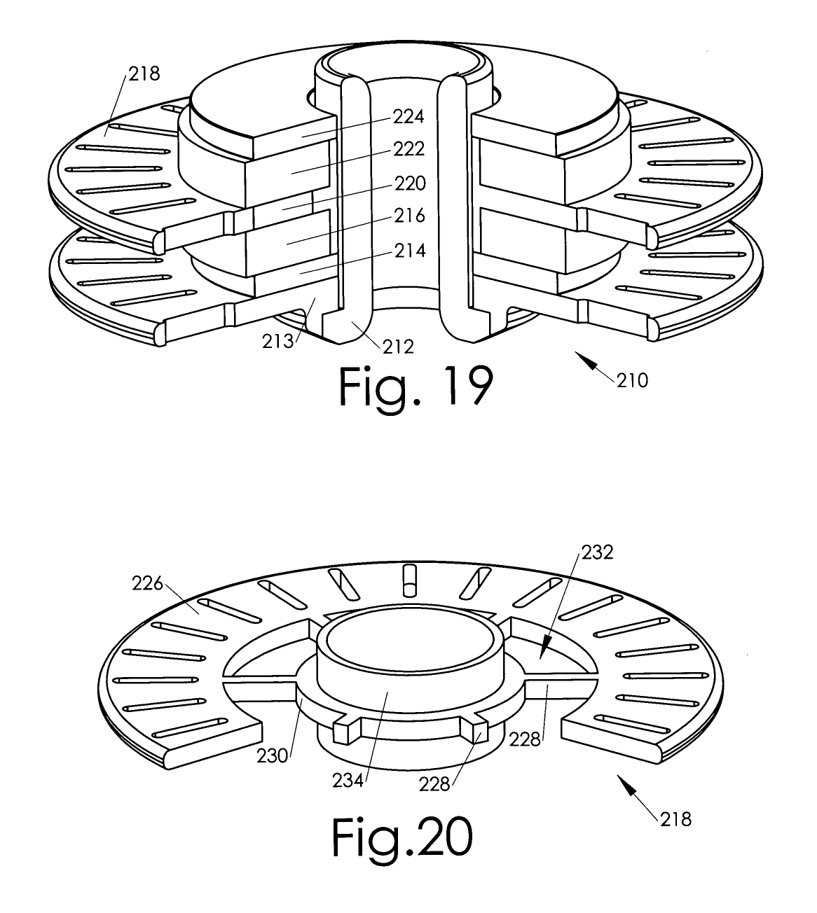

FIG. 19 illustrates a push-pull motor structure 210 utilizing this invention. The motor structure includes a pole plate 212 to which is coupled a non-magnetically conductive spacer 213. In one embodiment, the spacer also functions as a heatsink (as shown). A lower drive plate 214 is coupled to the spacer. A lower magnet 216 is magnetically coupled to the lower drive plate. A heatsink 218 is coupled between the lower magnet and an upper magnet 222. A set of magnetic material members 220 disposed between the webs of the heatsink magnetically couple the lower magnet to the upper magnet. The two magnets have their polarity in the same direction. An upper drive plate 224 is magnetically coupled to the upper magnet. Magnetic flux travels e.g. upward from the lower magnet, up through the set of plates or magnets which penetrate (or at least substantially penetrate) the heatsink, up through the upper magnet, radially inward through the upper drive plate and over the upper magnetic air gap, down through the pole piece, radially outward over the lower magnetic air gap, through the lower drive plate, and back up to the lower magnet, in a push-pull magnetic circuit. The spacer 213 substantially takes the back plate of the pole plate out of the magnetic circuit; therefore, the poleplate does not need a back plate, and the optional (and truncated) back plate merely provides self-centering for the heatsink which is configured to mate with the back plate. Two voice coils (not shown) are disposed in the respective magnetic air gaps, and are wound in opposite directions or are driven in opposite phase, as is known in the push-pull motor art.

FIG. 20 illustrates, with a view cutaway, one embodiment of a heatsink spacer 218 such as may be used with the motor structure of FIG. 19. The heatsink includes a body member 226 which is thermally coupled by webs 228 to an inner ring 230, with voids 232 between adjacent webs. In some embodiments, the inner ring may include extensions 234 extending in one or both axial directions to fit inside the ID of the respective magnets, to get an increased surface area of the heatsink material in closer proximity to the drive plates where heat and eddy currents would be generated by the voice coils, and, optionally, to also provide centering for the inner diameter of the magnets.

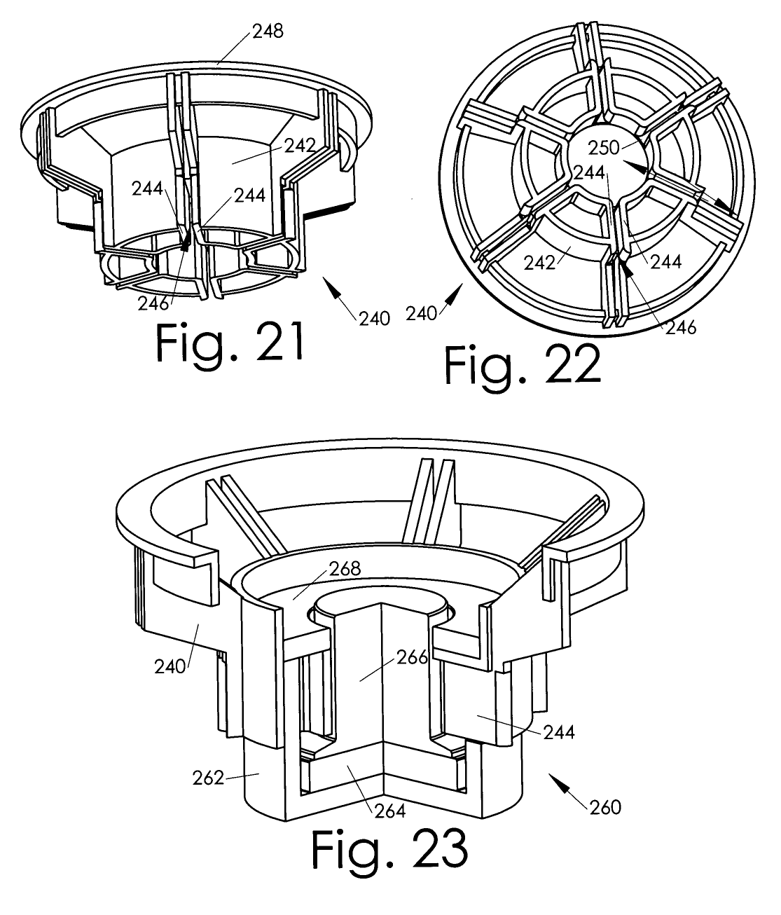

FIG. 21 illustrates, in perspective view, a simplified example of a heatsink basket 240 which may be used in practicing this invention. The heatsink basket includes a body 242 coupled to radial heat extraction members 244. In this implementation, the radial heat extraction members are formed in pairs, each surrounding an air ventilation gap 246. The body of the basket includes upper structures 248 for supporting the diaphragm assembly (not shown) of the speaker (not shown).

FIG. 22 illustrates, in a different perspective view, the heatsink basket 240, showing the inner ring 250 for sinking eddy currents. The arrow indicates airflow through the ventilation hole between or through the heat extraction members.

FIG. 23 illustrates, in perspective view with a cutaway, one embodiment of a motor structure 260 utilizing the basket of FIGS. 21-22. The motor structure includes a slotted cup 262. The radial heat extraction members of the basket fit down through the slots in the cup. The ventilation holes provide airflow through the slots, between or through the radial heat extraction members. A magnet 264 is magnetically coupled to the cup. A pole piece 266 is magnetically coupled to the magnet. An external ring plate 268 is magnetically coupled to the cup, and defines a magnetic air gap between itself and the pole piece.

The left side of the cutaway is cut through a position not including a slot in the cup, or in other words, a position where the cup extends into contact with the ring plate. The right side of the cutaway is cut through a slot in the cup, and, more specifically, directly through the airflow space between two radial heat extraction members of a pair that is positioned in that slot. The cup does not extend to the ring plate at this position, but ends at the bottom of the radial heat extraction members 244.

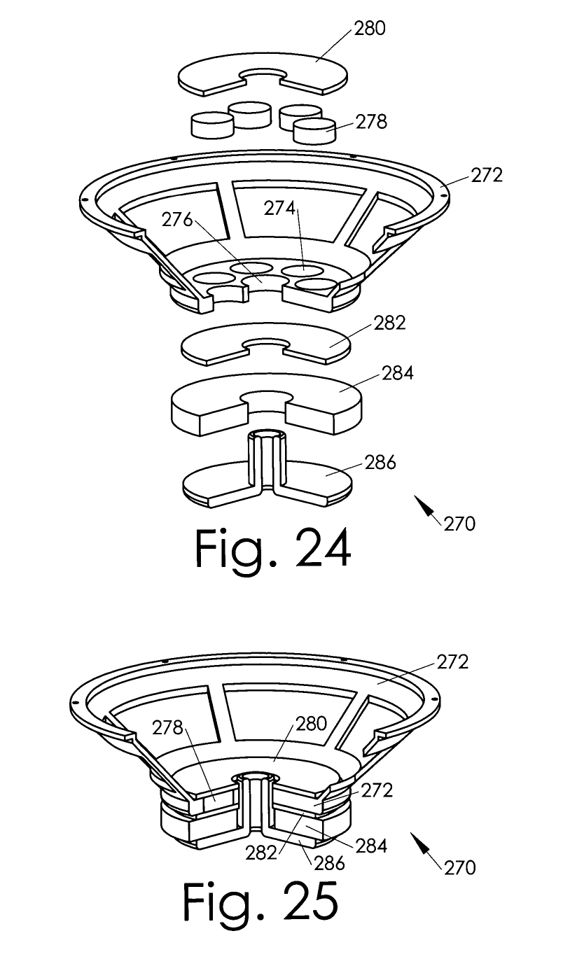

FIGS. 24-25 illustrate another embodiment of a dual gap motor structure 270 according to this invention. The motor structure includes a magnetically non-conductive basket 272 having the radial thermal extraction construction of this invention, including holes 274 through which magnetically conductive members 278 extend and a hole 276 through which a pole piece extends. An upper top plate 280 and a lower top plate 282 are magnetically coupled to opposite ends of the magnetically conductive members 278. A magnet 284 is magnetically coupled between the lower top plate and the pole plate 286. The two top plates define two magnetic air gaps with the pole piece. The webs between the holes through the basket provide radial thermal extraction, and the bulk of the basket serves as a heatsink. If the holes 274 do not extend to the pole piece hole 276, there exists an inner ring for sinking eddy current. The magnetically conductive members 278 may have any suitable shape. The basket may include a lip or rim (not shown) for providing positive positioning of the top plate(s).

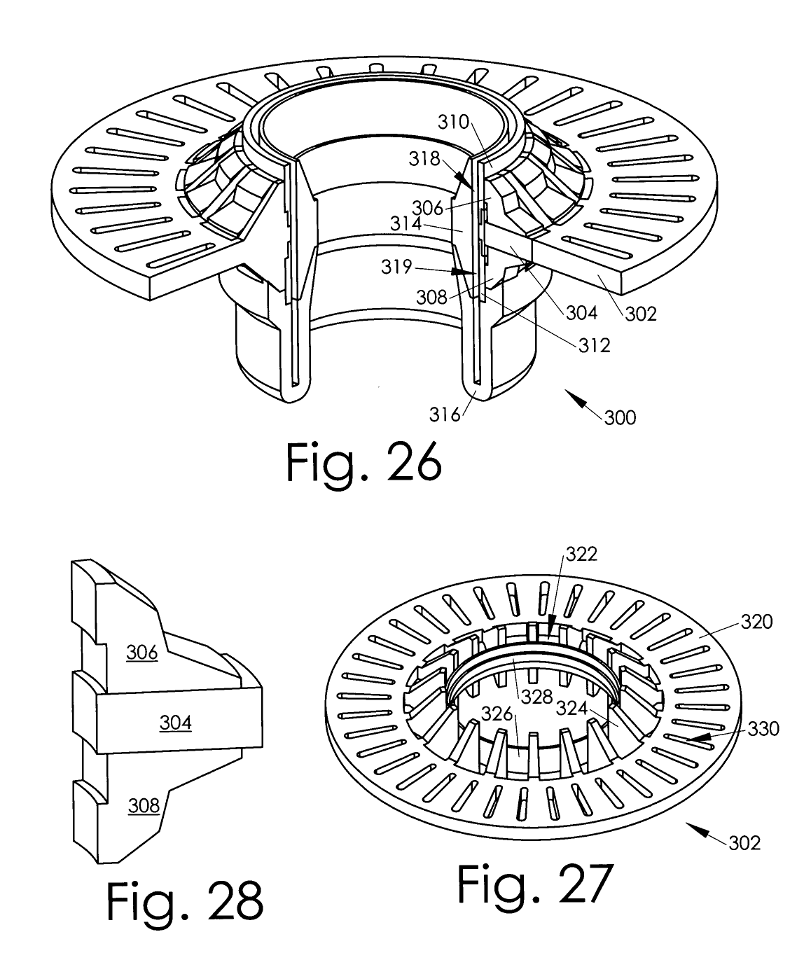

FIG. 26 illustrates yet another embodiment of the invention, configured as a push-pull motor structure 300. The motor structure includes a radial thermal extraction heatsink 302 within which are disposed a plurality of magnet segments 304. Each magnet segment has an upper plate connector 306 and a lower plate connector 308 magnetically coupled to it. The upper and lower plate connectors magnetically couple the magnet segment to an upper gap ring 310 and a lower gap ring 312, respectively. A pole piece 314 is supported by a pole support 316 and defines an upper magnetic air gap 318 between the pole piece and the upper gap ring, and a lower magnetic air gap 319 between the pole piece and the lower gap ring. Magnetic flux from the magnet segment flows through the upper plate connector to the upper gap ring, over the upper magnetic air gap, through the pole piece, back over the lower magnetic air gap, through the lower gap ring, and through the lower plate connector back to the magnet, in a push-pull magnetic circuit.

FIG. 27 illustrates the radial thermal extraction heatsink 302 in greater detail. The heatsink includes a radiator body 320 which includes a plurality of voids 322 for receiving the magnet segments (not shown). Webs 324 couple the radiator body to an inner ring 326 which is disposed between the upper and lower gap rings (not shown) to extract heat from the region of the voice coils (not shown) and which also serves as an induction ring to sink eddy currents. The inner ring may be adapted with an extrusion 328 which provides axial alignment and spacing of the gap rings.

In various embodiments, the webs 324 may have a variety of dimensions and geometries. In FIG. 26, they are dimensioned to just reach the upper and lower ends of the plate connectors. In other embodiments, they could, for example, extend all the way to the ends of the gap rings, or they could simply extend laterally inward such that the heatsink may be formed from a simple flat disc. In FIG. 26, they are shown as having an outer shape which is a simple straight line. In other embodiments, their shape could e.g. match the outer shape of the plate connectors, for a pleasing aesthetic look.

FIG. 28 illustrates one magnet segment 304 with its accompanying upper and lower plate connectors 306, 308. In other embodiments, the gap rings (not shown) and the plate connectors may be a monolithic whole, and the plate connectors may be unsegmented. However, in the embodiment shown, the plate connectors are segmented to facilitate assembling them with their magnet segment prior to charging of the magnet segment. Ideally, the assembly including the magnet segment and its two plate connectors has an overall outer dimension small enough to fit within the charging chamber of a common neo magnet charging apparatus. This allows full saturation of the magnet. In other embodiments, the magnet segment may be charged alone, prior to assembly with its plate connectors.

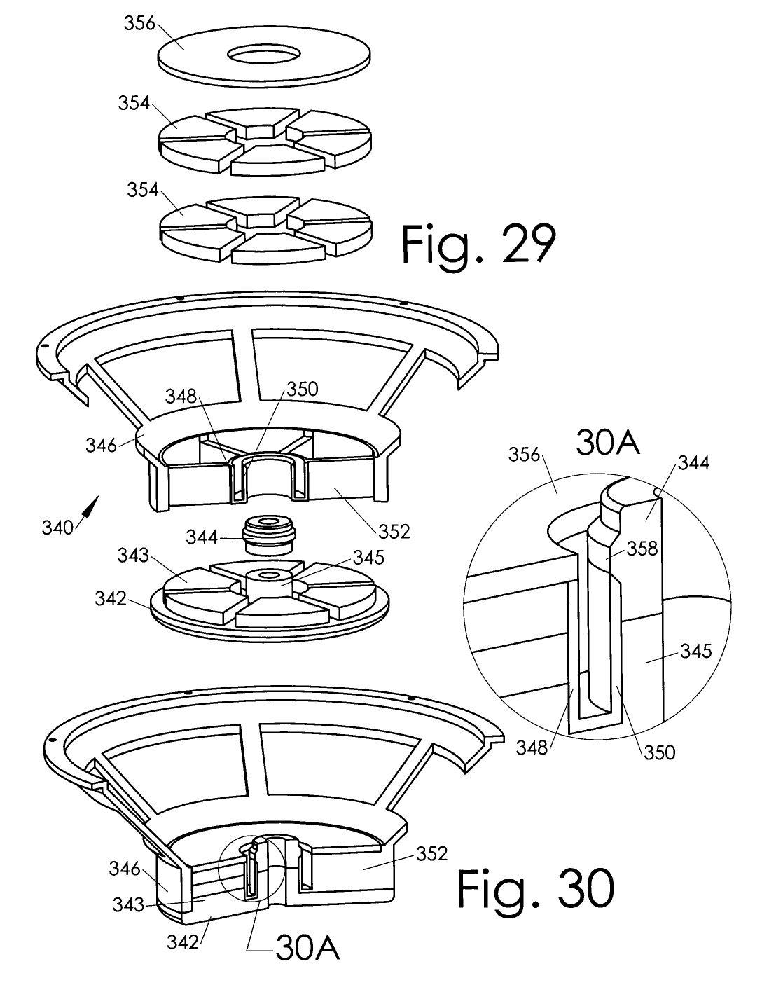

FIGS. 29 and 30, with detail view 30A, show another embodiment of a speaker motor structure 340. The motor structure includes a back plate which has integrated spacer elements 343 and a first partial pole piece 345. A second partial pole piece 344 couples to the first partial pole piece, such as by threads (not shown), glue, or other suitable means. A thermal extraction component 346 includes dual inner eddy current rings 348, 350 which are coupled to the body of the component by webs 352. Magnet segments 354 are disposed between the webs, and a top plate 356 is magnetically coupled to the magnet segments.

As more clearly shown in detail view 30A, the dual eddy current rings include a first ring 348 similar to those described above, which is disposed below the outer diameter of the magnetic air gap, and a second ring 350 which is disposed below the inner diameter of the magnetic air gap. The inner ring could, in other embodiments, be completely separate from the basket or heatsink, but in the embodiment shown, it is an integral portion of the basket, and thus serves to provide centering of the basket and the two portions of the pole piece. The upper portion 344 of the pole piece includes a radial extension 358 which forms and focuses the magnetic air gap. The transition from this extension to the main cylinder of the pole piece may be angled, as shown, or it may be straight as in a conventional t-pole.

One disadvantage of a conventional t-pole is that it is asymmetric, in that above the upper end of the magnetic air gap there is no pole piece material, but below the bottom of the magnetic air gap there is the cylindrical body of the pole piece. This asymmetry produces an asymmetric fringing field. One disadvantage of a conventional extended pole piece, which is straight and cylindrical and extends some distance beyond the magnetic air gap, is that the cylindrical portions that are just outside the magnetic air gap are at essentially the same distance from the top plate as are the portions that are inside the magnetic air gap (because the extended pole is a cylinder). Although this results in a symmetric fringe field, more of the total magnetic flux spreads out into the fringe field, creating a less focused gap. The hybrid extended/t-pole of this embodiment of the invention overcomes this disadvantage in that the body of the pole piece is set back from the top plate, except for the extension 358. This produces a tighter, more well-defined magnetic flux field about the magnetic air gap.

Another disadvantage of a conventional t-pole is that its upper surface is even with the top plate and, if the speaker is driven hard enough that the voice coil assembly extends completely out of the magnetic air gap, and if the bobbin rocks, the bobbin can impact and perhaps even become stuck on the top of the t-pole. The present invention overcomes this problem, as well, in that the hybrid extended/t-pole extends farther upward than the top plate, making it significantly less likely that the bobbin will reach the top of the pole piece. Even if the bobbin were to rock, the angled transition from the pole piece cylinder to the extension 358 will dramatically soften the impact of the bobbin, and guide the bobbin back into the magnetic air gap.

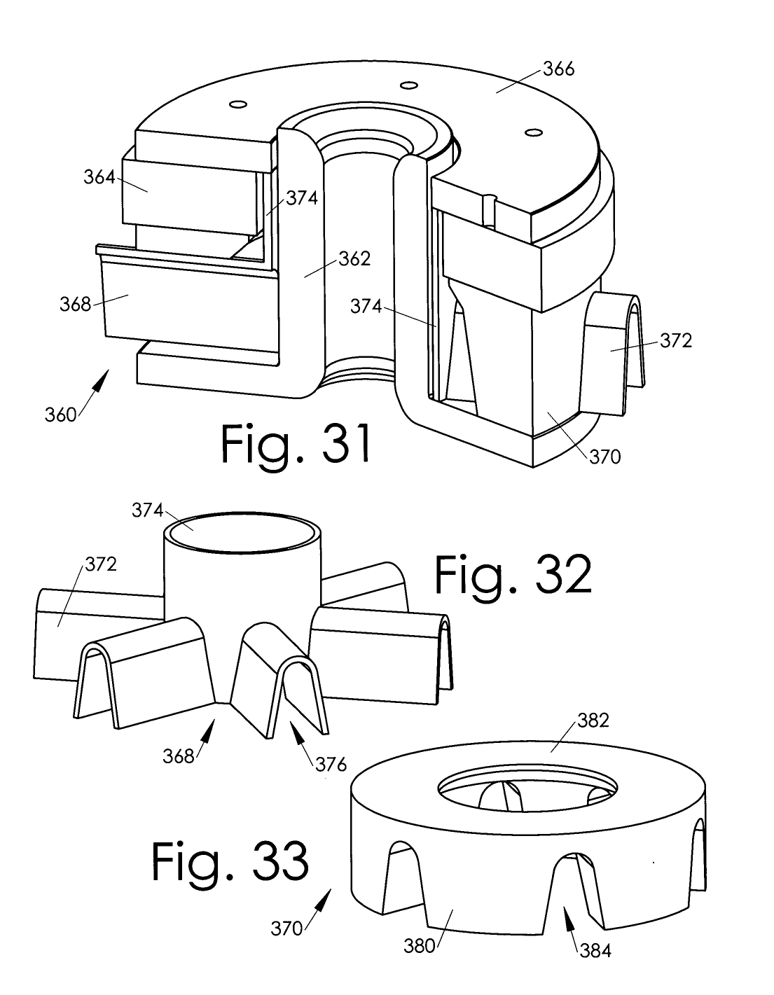

FIG. 31 illustrates a motor structure 360 which is, generally speaking, an external magnet geometry version of the motor structure of FIG. 23. The motor structure includes a pole plate 362, an external ring magnet 364, and an external ring plate 366. The magnet is magnetically coupled to the back plate by a spacer 370. A radial thermal extraction member 368 includes radial spokes 372 which extend outward through the spacer, and an inner ring 374 which is in close thermal contact with the voice coil (not shown) and sinks eddy currents.

FIG. 32 illustrates the radial thermal extraction member 368, with its inner ring 374 and radial spokes 372. In some embodiments, the radial spokes provide not only a thermal path through their aluminum or other material, but also a thermal path through the ambient air which can pass through radial vents 376, contained within the radial spokes. The radial thermal extraction member can simply be a heatsink, as shown, or it can extend to form the basket of the speaker.

FIG. 33 illustrates the spacer 370, including its axially extending portions 380 which determine the distance between the back plate and the magnet (not shown), its upper surface 382 which magnetically couples to the magnet, and its openings 384 through which the radial spokes of the radial thermal extraction member extend.

### CONCLUSION

The foregoing have been illustrations of the principles of the invention, and are not an exhaustive listing of its permutations. Many modifications may be made within the scope of this disclosure. For example, instead of using segmented steel members between the ring magnets in the configuration of FIG. 7, they could instead be segmented magnets. Or, alternatively, instead of them being separate members, they could be formed as integral structures with one or both of the ring magnets (which would, thus, not have flat surfaces but would, instead, be shaped to extend between the webs and contact the other magnet).

The sizes of the various magnets, plates, and other components are shown in the FIGS. for ease of illustration only. In practice, the skilled designer will select components of various geometries according to the needs of the application at hand. The skilled reader will further appreciate that the drawings are for illustrative purposes only, and are not scale models of optimized transducers. The magnets, plates, and other components will need to be sized and positioned according to the needs of the application at hand, which is well within the abilities of an ordinary skilled electromagnetic transducer engineer who is armed with the teachings of this patent. Magnets can be sized, or their power selected, according to their diameter, their thickness, surface area, and/or the strength and density of their magnetic material.

“Ring-shaped” or “annular” should not necessarily be interpreted to mean “cylindrical”, but can include other shapes, such as squares, which have holes through them and are thus substantially donut-shaped. “Disc-shaped” should not necessarily be interpreted to mean “cylindrical”, but can include other shapes, such as squares, which do not have meaningful holes through them. The skilled reader will readily appreciate that the various magnets illustrated in the drawings are shown with a particular N-S polarity orientation, and that the magnets can equally well be positioned with the opposite orientation.

Motors may generally be classified as having an external magnet geometry (in which a stack of ring plates and ring magnets surround a pole piece) or an internal magnet geometry (in which a cup contains a stack of magnets and plates). Pole plates and cups may collectively be termed yokes or magnetic return path members, as they serve as the return path for magnetic flux which has crossed over the magnetic air gap.

Materials may be classified as either magnetic materials or non-magnetic materials. Non-magnetic materials may also be termed non magnetically conductive materials; aluminum and chalk are examples of non-magnetic materials. Magnetic materials are classified as hard magnetic materials and soft magnetic materials. Hard magnetic materials are also called permanent magnets, and generate magnetic flux fields without outside causation. Soft magnetic materials are those which, although not permanent magnets, will themselves become magnetized in response to their being placed in a magnetic field. Soft magnetic materials include the ferrous metals such as steel and iron. It is not necessary that the magnetic material members which extend through the heatsink or the basket are all permanent magnets or all e.g. steel; in some embodiments, some of them may be hard magnets and the rest may be made of soft magnetic material.

Various embodiments have been described in terms of an internal magnet geometry, while others have been described in terms of an external magnet geometry. The skilled reader will appreciate that principles taught with reference to one geometry may often find applicability in the other geometry. An external magnet geometry transducer is said to have a cup, while an internal magnet geometry transducer is said to have a pole plate; cups and pole plates may generically be called magnetic return path members. The various magnets, plates, poles, cups, and so forth may be termed magnetic motor components and, together, they may be termed a motor assembly or a magnet/plate assembly. Although the invention has been described with reference to audio speakers, it is not necessarily thus limited. The invention may find utility in a variety of electromagnetic transducers.

The phrase “magnetically coupled to” is intended to mean “in magnetic communication with” or in other words “in a magnetic flux circuit with”, and not “mechanically affixed to by means of magnetic attraction.” The phrase “magnetic air gap” is intended to mean “gap over which magnetic flux is concentrated” and not limited to the case where such gap is actually filled with air; the gap could, in some applications, be filled with any suitable gas or liquid, or even be under vacuum. The skilled reader will appreciate that magnetic flux may be interpreted as flowing either from the north to the south, or from the south to the north.

When one component is said to be “adjacent” another component, it should not be interpreted to mean that there is absolutely nothing between the two components, only that they are in the order indicated. The various features illustrated in the figures may be combined in many ways, and should not be interpreted as though limited to the specific embodiments in which they were explained and shown.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

1. An electromagnetic transducer comprising:
a first magnetically conductive member;
a second magnetically conductive member;
a first non-magnetically conductive thermally conductive member disposed between the first and second magnetically conductive members; and
a plurality of third magnetically conductive members disposed within voids in the thermally conductive member and magnetically coupling the first magnetically conductive member to the second magnetically conductive member;
wherein the thermally conductive member includes outwardly extending members between which the voids are defined to conduct heat outwardly between the third magnetically conductive members.

2. The electromagnetic transducer of claim 1 wherein:
at least one of the first and second magnetically conductive members comprises a permanent magnet.

3. The electromagnetic transducer of claim 2 wherein:
the third magnetically conductive members comprise soft magnetic material members.

4. The electromagnetic transducer of claim 2 wherein:
the third magnetically conductive members comprise permanent magnets.

5. The electromagnetic transducer of claim 1 wherein:
at least one of the first and second magnetically conductive members comprises a soft magnetic material member.

6. The electromagnetic transducer of claim 5 wherein:
the third magnetically conductive members comprise soft magnetic material members.

7. The electromagnetic transducer of claim 6 wherein:
a subset of the third magnetically conductive members comprise permanent magnets.

8. The electromagnetic transducer of claim 1 wherein the non-magnetic thermally conductive member comprises:
a heatsink comprising aluminum.

9. The electromagnetic transducer of claim 8 wherein:
the heatsink is configured as a speaker basket.

10. The electromagnetic transducer of claim 1 wherein:
the first non-magnetically conductive thermally conductive member is configured as a speaker basket.

11. The electromagnetic transducer of claim 1 wherein:
the third magnetically conductive members comprise extensions integrally constructed with the first magnetically conductive member.

12. The electromagnetic transducer of claim 1 wherein the thermally conductive member further comprises:
a first electrically conductive ring coupled to the outwardly extending members.

13. The electromagnetic transducer of claim 12 wherein:
one of the first and second magnetically conductive members comprises a ring magnet having an inner dimension; and
the first electrically conductive ring extends axially between the inner dimension of the ring magnet and a pole piece of the electromagnetic transducer.

14. The electromagnetic transducer of claim 12 wherein the thermally conductive member further comprises:
a second electrically conductive ring coupled to the outwardly extending members, wherein the first and second electrically conductive rings are disposed on opposite sides of a magnetic air gap of the electromagnetic transducer.

15. The electromagnetic transducer of claim 1 wherein:
the third magnetically conductive members are substantially wedge shaped.

16. The electromagnetic transducer of claim 1 wherein:
the third magnetically conductive members are substantially round shaped.

17. The electromagnetic transducer of claim 1 further comprising:
a second non-magnetic thermally conductive member; and
a plurality of fourth magnetically conductive members disposed within voids in the second thermally conductive member and magnetically coupled to the first magnetically conductive member.

18. The electromagnetic transducer of claim 1 wherein:
the electromagnetic transducer comprises a motor having an external magnet geometry.

19. The electromagnetic transducer of claim 1 wherein:
the electromagnetic transducer comprises a motor having an internal magnet geometry.

20. The electromagnetic transducer of claim 19 wherein:
the first magnetically conductive member comprises a lower portion of a cup;
the second magnetically conductive member comprises an upper portion of the cup.

21. The electromagnetic transducer of claim 1 further comprising:
a substantially radial ventilation hole through at least one of the outwardly extending members of the thermally conductive member.

22. The electromagnetic transducer of claim 21 wherein:
the ventilation hole is surrounded by material of the outwardly extending member.

23. The electromagnetic transducer of claim 1 comprising:
a push-pull magnetic circuit.

24. The electromagnetic transducer of claim 23 wherein:
the first and second magnetically conductive members comprise upper and lower ring plates, respectively;
the third magnetically conductive members comprise hard magnet segments; and
wherein the electromagnetic transducer further comprises,
a plurality of plate connectors magnetically coupling the upper and lower gap rings to the hard magnet segments.

25. The electromagnetic transducer of claim 24 wherein:
the plurality of plate connectors comprises an upper plate connector segment and a lower plate connector segment for each of the hard magnet segments.

26. The electromagnetic transducer of claim 25 wherein:
the outwardly extending members comprise webs which extend axially between adjacent plate connectors.

27. The electromagnetic transducer of claim 25 wherein:
the thermally conductive member comprises a speaker basket.

28. An audio speaker motor structure having an external magnet motor geometry and comprising:
a pole piece;
a stack of at least two magnetically conductive members, the stack including,
at least one permanent magnet, and
at least one plate defining at least one magnetic air gap with the pole piece; and
a thermally conductive heatsink including,
an inner ring, and
a plurality of thermally conductive webs coupled to the inner ring;
wherein at least one of the magnetically conductive members in the stack comprises,
a plurality of segmented members disposed between the webs of the heatsink.

29. The audio speaker motor structure of claim 28 wherein:
the plurality of segmented members together comprise the permanent magnet.

30. The audio speaker motor structure of claim 28 wherein:
the plurality of segmented members together comprise a soft magnet.

31. The audio speaker motor structure of claim 30 wherein:
the plurality of segmented members together comprise the plate.

32. The audio speaker motor structure of claim 28 further comprising:
the heatsink further comprises a speaker basket.

33. The audio speaker motor structure of claim 28 further comprising:
a second such heatsink; and
wherein a second one of the magnetically conductive members in the stack comprises,
a second plurality of segmented members disposed between the webs of the second heatsink.

34. The audio speaker motor structure of claim 28 wherein:
the inner ring of the heatsink is electrically conductive.

35. The audio speaker motor structure of claim 34 wherein:
the heatsink further includes an outer body coupled to the webs, and the heatsink as a whole is electrically conductive.

36. The audio speaker motor structure of claim 28 further comprising:
the first thermally conductive heatsink further including,
an outer member coupled to the webs;
a second thermally conductive heatsink including,
an inner ring,
an outer member, and
a plurality of thermally conductive webs coupling the inner ring to the outer member; and
a plurality of magnetically conductive members disposed between the webs of the second thermally conductive heatsink.

37. The audio speaker motor structure of claim 28 comprising:
a push-pull magnetic circuit.

38. An audio speaker motor structure having an internal magnet motor geometry and comprising:
a lower cup portion including an outer rim and an inner base surface;
a permanent magnet magnetically coupled to the inner base surface of the lower cup portion;
a plate magnetically coupled to the permanent magnet;
a thermally conductive heatsink coupled to the outer rim of the lower cup portion and including,
an inner ring, and
a plurality of webs coupled to the inner ring;
a plurality of magnetically conductive members disposed between the webs of the heatsink and coupled to the lower cup portion; and
an upper cup portion coupled to the plurality of magnetically conductive members.

39. The audio speaker motor structure of claim 38 wherein:
the plurality of magnetically conductive members comprises soft magnets.

40. The audio speaker motor structure of claim 39 wherein:
a subset the plurality of magnetically conductive members comprises permanent magnets.

41. The audio speaker motor structure of claim 38 wherein the heatsink further includes:
an outer body coupled to the webs.

42. A method of cooling an audio speaker motor structure, the method comprising:
conducting magnetic flux from a first magnetic material member, through a plurality of second magnetic material members, to a third magnetic material member;
wherein the first magnetic material member, the second magnetic material members, and the third magnetic material member are disposed at different axial positions along an axis of the audio speaker motor structure;
wherein there are spaces between adjacent ones of the plurality of second magnetic material members;
absorbing heat by an inner ring which is coaxially disposed adjacent the second magnetic material members; and
conducting the heat from the inner ring through a plurality of webs which are coupled to the inner ring and which are disposed between respective adjacent ones of the second magnetic material members, to an outer heatsink member.

43. The method of claim 42 further comprising:
sinking electrical eddy current in the inner ring, in response to generation of the eddy current by a voice coil of the audio speaker motor structure.

44. The method of claim 43 further comprising:
sinking electrical eddy current through the outer heatsink member.

45. The method of claim 42 wherein:
conducting the heat from the inner ring through the webs to the outer heatsink member comprises conducting the heat to a basket of an audio speaker which includes the audio speaker motor structure.

46. The method of claim 42 further comprising:
passing ventilation air through a hole in the plurality of webs, the air flowing between an inside of the audio speaker motor structure and an outside of the audio speaker motor structure.
